(19) United States
(12) Patent Application Publication
(10) Pub. No.: US 2024/0009887 A1
(43) Pub. Date: Jan. 11, 2024

(54) PROCESS FOR FORMING CERAMIC BODIES WITH INTERNAL PASSAGES OR CHAMBERS USING POWDER PRESSING AROUND AN INTERNAL MOLD

(71) Applicant: CORNING INCORPORATED, CORNING, NY (US)

(72) Inventors: Didier Claude Jacob, Rix (FR); Jean-Pierre Henri René Lereboullet, Bois le Roi (FR); James Scott Sutherland, Painted Post, NY (US); Sophie Annie Vallon, Bretigny Sur Orge (FR); Frédéric Camiel Verveynne, Saint Mammes (FR)

(21) Appl. No.: 18/036,475

(22) PCT Filed: Nov. 19, 2021
(86) PCT No.: PCT/US21/60070

§ 371 Date: May 11, 2023

Related U.S. Application Data
(60) Provisional application No. 63/119,643, filed on Nov. 30, 2020.

(51) Int. Cl. B28B 7/34; B28B 7/18

(52) U.S. Cl. CPC B28B 7/342; B28B 7/18

(57) ABSTRACT

A process (10) of forming an internal mold (IM) and using the internal mold (IM) to press-mold an internal passage or an internal cavity within a ceramic body includes making or obtaining first and second flexible mold halves (102,104); molding a positive internal mold (IM) of a meltable or sublimable or otherwise heat-removeable material; pressing a volume of binder-coated ceramic powder with the positive internal mold (IM) inside the volume of powder to form a pressed body; heating the pressed body to remove the positive internal mold from the pressed body; and sintering the pressed body to form a monolithic ceramic body having an internal passage or an internal cavity.

### CROSS REFERENCE TO RELATED APPLICATIONS

This application claims the benefit of priority under 35 U.S.C. § 119 of U.S. Provisional Application No. 63/119,643, filed Nov. 30, 2020, the content of which is incorporated herein by reference in its entirety.

### FIELD OF THE DISCLOSURE

The disclosure relates to methods of fabrication ceramic, particularly silicon carbide, structures containing internal passages or chambers, by powder pressing of binder-coated ceramic powder around an internal mold.

### BACKGROUND

Ceramic and particularly silicon carbide (SiC) is a desirable material for fluidic modules for flow chemistry production and/or laboratory work and for structures for other technical uses. SiC has relatively high thermal conductivity, useful in performing and controlling endothermic or exothermic reactions. SiC has good physical durability and thermal shock resistance. SiC also possesses extremely good chemical resistance. But these properties, combined with high hardness and abrasiveness, make the practical production of SiC structures with internal features, such as SiC flow modules with tortuous internal passages, challenging.

Accordingly, there is a need for ceramic, particularly SiC fluidic modules and other structures, and methods of fabricating ceramic and SiC fluidic modules and other structures, with internal passages or chambers.

### SUMMARY OF THE DISCLOSURE

According to aspects of the present disclosure, a process is provided of forming an internal mold and using the internal mold to press-mold an internal passage or an internal cavity within a ceramic body, the process comprising making or obtaining first and second flexible mold halves which together form a flexible mold pair having an internal mold cavity corresponding to the shape and volume of a positive internal mold to be formed; molding a positive internal mold inside the flexible mold pair, the positive internal mold formed of a meltable or sublimable or otherwise heat-removeable material; removing the first and second flexible mold halves from the positive internal mold by bending or pealing back the flexible mold halves; pressing a volume of binder-coated ceramic powder with the positive internal mold inside the volume of powder to form a pressed body; heating the pressed body to remove the positive internal mold from the pressed body; and sintering the pressed body to form a monolithic ceramic body having an internal passage or an internal cavity.

According to embodiments, pressing the volume of binder-coated ceramic powder comprises uniaxial pressing.

According to embodiments, pressing the volume of binder-coated ceramic powder comprises isostatic pressing.

According to embodiments, heating the pressed body to remove the internal mold comprises pressing the pressed body while heating the pressed body.

According to embodiments, the first and second flexible mold halves have a relief angle on the internal mold cavity surface in the range of from 2 to 12 degrees.

According to embodiments, the first and second flexible mold halves have a relief angle within the internal mold cavity in the range of from 5 to 9 degrees.

According to embodiments, the first and second flexible mold halves are shaped such that contact surfaces between the first and second flexible mold halves extending away from contact lines adjacent the internal mold cavity extend in a direction non-perpendicular to surfaces of the internal mold cavity at said contact lines.

According to embodiments, the first and second flexible mold halves are shaped such that contact surfaces between the first and second flexible mold halves extending away from contact lines adjacent the internal mold cavity extend in a direction forming an acute angle with the nearest surface of the internal mold cavity.

According to embodiments, the second flexible mold half, when assembled with the first flexible mold half, nests inside the first flexible mold half against a surface of the first flexible mold half partially surrounding the internal mold cavity surfaces of the second flexible mold half. According other embodiments in the form of an additional variation of the immediately previous embodiments, the first flexible mold half, when assembled with the second flexible mold half, nests inside the second flexible mold half against a surface of the second flexible mold half partially surrounding the internal mold cavity surfaces of the first flexible mold half.

According to embodiments, the first and second flexible mold halves have a release angle in the range of from 2 to 12 degrees wherever they nest inside each other.

According to embodiments, the first and second flexible mold halves have a release angle in the range of from 2 to 12 degrees where the second flexible mold half nests inside the first flexible mold half.

According to embodiments, portions of the respective first and second flexible molds which nest inside each other extend continuously around the internal mold cavity.

According to embodiments, making or obtaining first and second flexible mold halves comprises casting or molding the first flexible mold half with a master mold, positioning an insert mold, corresponding to the shape of the internal mold to be formed later, in the first flexible mold half, and casting or molding the second flexible mold half on the first flexible mold half with the insert mold positioned therein.

According to embodiments, molding a positive internal mold inside the flexible mold pair comprises feeding a meltable or sublimable or otherwise heat-removeable material in liquid form into the internal mold cavity of the flexible mold pair, and cooling, or allowing to cool, the flexible mold pair to solidify the material.

According to embodiments, feeding a meltable or sublimable or otherwise heat-removeable material in liquid form into the internal mold cavity of the flexible mold pair comprises feeding the material by a gravity-driven flow.

According to embodiments, feeding a meltable or sublimable or otherwise heat-removeable material in liquid form into the internal mold cavity of the flexible mold pair comprises withdrawing the material in liquid form from beneath a surface of a liquid pool of the material and allowing the withdrawn liquid to flow by gravity into the internal mold cavity.

According to embodiments, the meltable or sublimable or otherwise heat-removeable material comprises a rosin-containing wax.

According to embodiments, the first and second flexible mold halves comprise silicone.

Additional features and advantages will be set forth in the detailed description which follows, and will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary and are intended to provide an overview or framework to understanding the nature and character of the disclosure and the appended claims.

The accompanying drawings are included to provide a further understanding of principles of the disclosure, and are incorporated in, and constitute a part of, this specification. The drawings illustrate one or more embodiment(s) and, together with the description, serve to explain, by way of example, principles and operation of the disclosure. It is to be understood that various features of the disclosure disclosed in this specification and in the drawings can be used in any and all combinations. By way of non-limiting examples, the various features of the disclosure may be combined with one another according to the following embodiments.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

In the drawings:

FIG. 1 is a flow chart of an embodiment of a process;

FIG. 2 is a diagrammatic plan view an embodiment of an in internal mold;

FIG. 3 and FIG. 4 are a diagrammatic cross-sectional partial views of embodiments of first and second flexible mold halves engaged together;

FIG. 5 is a cross sectional diagram illustrating an embodiment of a process of forming a second flexible mold half;

FIG. 6 is a step-wise is a cross sectional diagram illustrating an embodiment of a process of filling a flexible mold; and

FIG. 7 is a cross sectional diagram illustrating another embodiment of a process of filling a flexible mold.

### DETAILED DESCRIPTION OF THE PREFERRED EMBODIMENTS

Additional features and advantages will be set forth in the detailed description which follows and will be apparent to those skilled in the art from the description or recognized by practicing the embodiments as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

For purposes of this disclosure, the term “coupled” (in all of its forms: couple, coupling, coupled, etc.) generally means the joining of two components directly or indirectly to one another. Such joining may be stationary in nature or movable in nature. Such joining may be achieved with the two components and any additional intermediate members being integrally formed as a single unitary body with one another or with the two components. Such joining may be permanent in nature, or may be removable or releasable in nature, unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In embodiments, “substantially” may denote values within about 10% of each other, such as within about 5% of each other, or within about 2% of each other.

Directional terms as used herein—for example up, down, right, left, front, back, top, bottom, above, below, and the like—are made only with reference to the figures as drawn and are not intended to imply absolute orientation.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, a “tortuous” passage refers to a passage having no line of sight directly through the passage and with a path of the passage having at least two differing radii of curvature, the path of the passage being defined mathematically and geometrically as a curve formed by successive geometric centers, along the passage, of successive minimum-area planar cross sections of the passage (that is, the angle of a given planar cross section is the angle which produces a minimum area of the planar cross section at the particular location along the passage) taken at arbitrarily closely spaced successive positions along the passage. Typical machining-based forming techniques are generally inadequate to form such a tortuous passage. Such passages may include a division or divisions of a passage into subpassages (with corresponding subpaths) and a recombination or recombinations of subpassages (and corresponding subpaths).

As used herein a “monolithic” ceramic or silicon carbide body or structure of course does not imply zero inhomogeneities in the ceramic structure at all scales. A “monolithic” silicon carbide structure or a “monolithic” silicon carbide fluidic module, as the term “monolithic” is defined herein, refers to a silicon carbide structure or fluidic module, with one or more tortuous passages extending therethrough, in which no (other than the passage(s)) inhomogeneities, openings, or interconnected porosities are present in the ceramic structure having a length greater than the average perpendicular depth of one or more internal passages or cavities from the external surface of the structure or body. Providing such a monolithic ceramic or silicon carbide body or structure helps ensure fluid tightness and good pressure resistance of a flow reactor fluidic module or similar product.

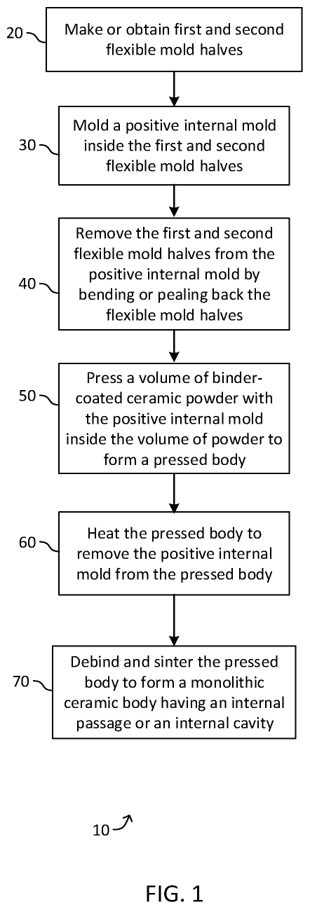

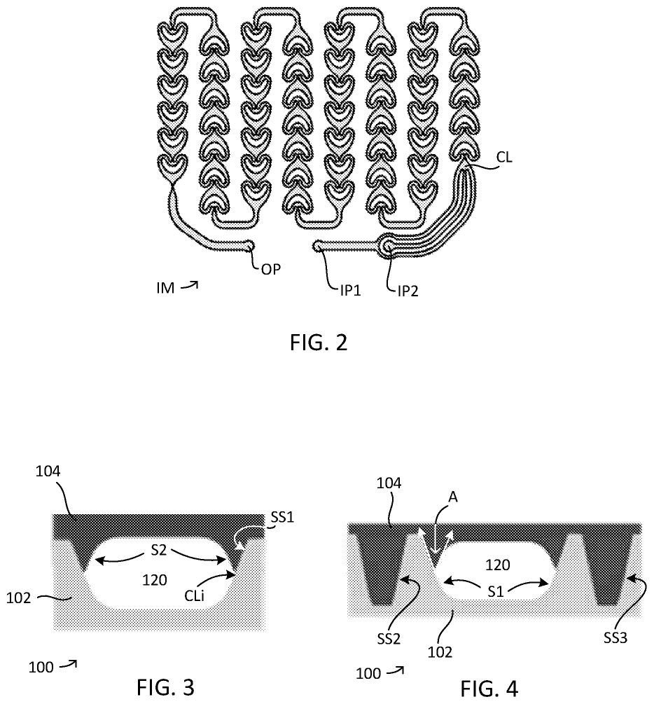

FIG. 1 is a diagram for an embodiment of a process of forming an internal mold and using the internal mold to press-mold an internal passage or an internal cavity within a ceramic body. The process 10 comprises step or item 20, making or obtaining first and second flexible mold halves. The flexible mold halves together form a flexible mold pair having an internal mold cavity corresponding to the shape and volume of a positive internal mold to be formed. (An example of such an internal mold is shown and described below with respect to FIG. 2.)

The process 10 further comprises step or item 30, molding a positive internal mold inside the flexible mold pair. The positive internal mold is formed of a meltable or sublimable or otherwise heat-removeable material. Next in the process 10, the step or item 40 comprises removing the first and second flexible mold halves from the positive internal mold by bending or pealing back the flexible mold halves. Next the step or item 50 comprises pressing a volume of binder-coated ceramic powder with the positive internal mold inside the volume of powder, to form a pressed body. Then the step or item 60 comprises heating the pressed body to remove the positive internal mold from the pressed body. Finally, the step or item 70 comprises (debinding and) sintering the pressed body to form a monolithic ceramic body having an internal passage or an internal cavity.

The first and second flexible mold halves can comprise silicone flexible mold halves. The meltable or sublimable or otherwise heat-removeable material can comprise a rosin-containing wax. The internal mold material can be an organic material such as an organic thermoplastic. The internal mold material can include organic or inorganic particles suspended or otherwise distributed within the material as a way of decreasing expansion during heating/melting. In embodiments, the material of the internal mold is desirably a relatively incompressible material—specifically a material with low rebound after compression relative to the rebound of the pressed ceramic or SiC powder after compression. Internal mold materials loaded with particles can exhibit lower rebound after compression. Internal mold materials which are capable of some degree of non-elastic deformation under compression also naturally tend to have low rebound (e.g., materials with high loss modulus). Polymer substances with little or no cross-linking, for example, and/or materials with some local hardness or brittleness which enables localized fracturing or micro-fracturing upon compression can exhibit low rebound. Useful internal mold materials can include waxes with suspended particles such as carbon and/or inorganic particles, rosin containing waxes, high modulus brittle thermoplastics, organic solids suspended in organic fats such as cocoa powder in cocoa butter, and combinations thereof. Low melting point metal alloys also may be useful as internal mold materials, particularly alloys having low or no expansion on melting.

Pressing the volume of binder-coated ceramic powder can comprise uniaxial pressing or isostatic pressing. Some degree of pressing or pressure may also be used as part of the step or item of heating the pressed body to remove the internal mold.

As mentioned above, FIG. 2 shows a plan view of an embodiment or example of an internal mold IM which can be used in embodiments of the processes described herein. In the case of the internal mold of FIG. 2, the mold is of a fluid passage shape having to input port positions IP1 and IP2 for two different fluids to be pumped into the passage. A contact location CL is provided where the two fluids first meet, followed by a long tortuous passage in which the fluids are continuously mixed together, followed by an output port location OP. the flexible mold halves of the process of FIG. 1 can be used to form internal mold having the shape shown in FIG. 2, or internal molds of other shapes.

FIGS. 3 and 4 show diagrammatic cross-sectional partial views of embodiments of first and second flexible mold halves 102, 104 engaged together to form a flexible mold pair 100 having an internal mold cavity 120. As seen in the figures, it is useful for the first and second flexible mold halves each to have a relief angle on the surface internal mold cavity surface in the range of from 2 to 12 degrees, or in the range of from 5 to 9 degrees.

As also seen in FIG. 3, according to embodiments, the second flexible mold half 104, when assembled with the first flexible mold half 102, can nest inside the first flexible mold half 102 against a surface SS1 of the first flexible mold half 102 partially surrounding the internal mold cavity surfaces S2 of the second flexible mold half 104. Additionally, as in the embodiment illustrated in FIG. 4, the first flexible mold half 102, when assembled with the second flexible mold half 104, can nest inside the second flexible mold half 104 against a surface SS2 of the second flexible mold half 104 partially surrounding the internal mold cavity surfaces S1 of the first flexible mold half 102. This interleaving nesting can even continue to a third interface SS3 between the flexible mold halves 102, 104, as further shown in FIG. 4.

In another way of considering the features of FIG. 3, the first and second flexible mold halves 102, 104 are shaped such that contact surfaces between the first and second flexible mold halves 102, 104 extending away from contact lines Cli adjacent the internal mold cavity 120 extend in a direction non-perpendicular to surfaces of the internal mold cavity at said contact lines. This allows any forces within the internal mold cavity 120 to assist in pressing the mold halves against each other at said contact surfaces. Expressed in still one other way, the first and second flexible mold halves 102, 104, are shaped such that contact surfaces between the first and second flexible mold halves extending away from contact lines CLi adjacent the internal mold cavity 120 extend in a direction forming an acute angle A with the nearest surface of the internal mold cavity 120, as shown in FIG. 4.

The first and second flexible mold halves can have a release angle in the range of from 2 to 12 degrees or from 5 to 9 degrees wherever they nest inside each other, or wherever the second flexible mold half nests inside the first flexible mold half.

The portions of the respective first and second flexible molds 102, 104 which nest inside each other can extend continuously (without break) around the internal mold cavity 120.

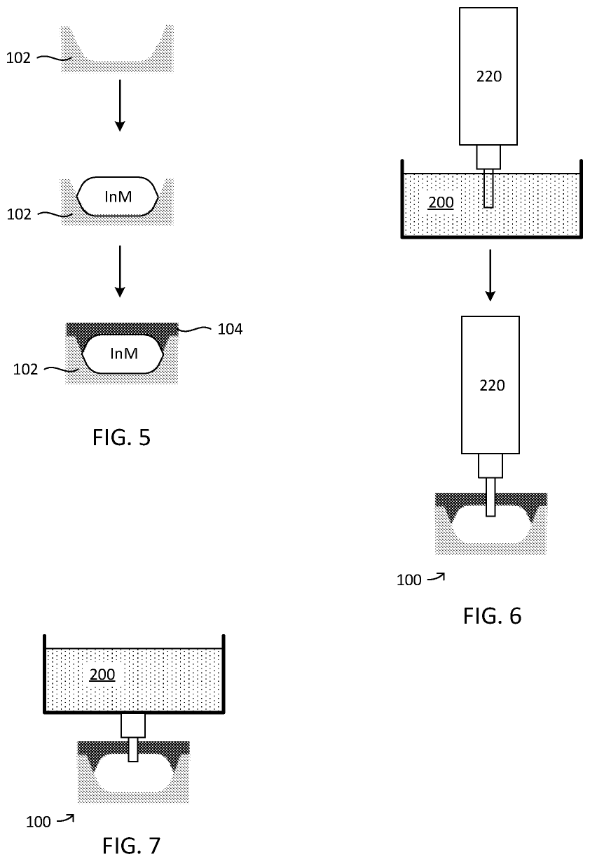

FIG. 5 is a cross sectional diagram illustrating an embodiment of a process of forming a flexible mold pair 102, 104, particularly of forming a second flexible mold half 104. Making or obtaining first and second flexible mold halves can comprise casting or molding the first flexible mold half 102 with a master mold (not shown), then positioning an insert mold IM, corresponding to the shape of the internal mold to be formed later, in the first flexible mold half 102, and then casting or molding the second flexible mold half 104 on the first flexible mold half 102 with the insert mold IM positioned therein. A release agent or other coating may be used on the first half 102 to prevent adhesion of the second half 104 during molding of the second half 104.

Molding a positive internal mold inside the flexible mold pair can comprise feeding a meltable or sublimable or otherwise heat-removeable material in liquid form into the internal mold cavity of the flexible mold pair, and cooling, or allowing to cool, the flexible mold pair to solidify the material. Feeding a meltable or sublimable or otherwise heat-removeable material in liquid form into the internal mold cavity of the flexible mold pair can comprise feeding the material by a gravity-driven flow.

FIGS. 6 and 7 are step-wise cross sectional diagrams illustrating embodiments of a process of filling a flexible mold. As illustrated in the figures, feeding a meltable or sublimable or otherwise heat-removeable material in liquid form into the internal mold cavity of the flexible mold pair can comprise withdrawing the material in liquid form from beneath a surface of a liquid pool 200 of the material and allowing the withdrawn liquid to flow by gravity into the internal mold cavity. This can be achieved by two separate steps such as withdrawal into a cylinder 220 for later delivery under gravity only as in FIG. 6, or by direct gravity driven flow from a liquid pool 200 as in FIG. 7.

Additional features and advantages will be set forth in the detailed description which follows, and will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary and are intended to provide an overview or framework to understanding the nature and character of the disclosure and the appended claims.

The accompanying drawings are included to provide a further understanding of principles of the disclosure, and are incorporated in, and constitute a part of, this specification. The drawings illustrate one or more embodiment(s) and, together with the description, serve to explain, by way of example, principles and operation of the disclosure. It is to be understood that various features of the disclosure disclosed in this specification and in the drawings can be used in any and all combinations. By way of non-limiting examples, the various features of the disclosure may be combined with one another according to the following embodiments.

The processes disclosed can be useful to form ceramic structures, particularly silicon carbide structures which are useful as fluidic modules in modular flow reactors.

Such devices produced by the methods disclosed herein are generally useful in performing any process that involves mixing, separation including reactive separation, extraction, crystallization, precipitation, or otherwise processing fluids or mixtures of fluids, including multiphase mixtures of fluids—and including fluids or mixtures of fluids including multiphase mixtures of fluids that also contain solids—within a microstructure. The processing may include a physical process, a chemical reaction defined as a process that results in the interconversion of organic, inorganic, or both organic and inorganic species, a biochemical process, or any other form of processing. The following non-limiting list of reactions may be performed with the disclosed methods and/or devices: oxidation; reduction; substitution; elimination; addition; ligand exchange; metal exchange; and ion exchange. More specifically, reactions of any of the following non-limiting list may be performed with the disclosed methods and/or devices: polymerisation; alkylation; dealkylation; nitration; peroxidation; sulfoxidation; epoxidation; ammoxidation; hydrogenation; dehydrogenation; organometallic reactions; precious metal chemistry/homogeneous catalyst reactions; carbonylation; thiocarbonylation; alkoxylation; halogenation; dehydrohalogenation; dehalogenation; hydroformylation; carboxylation; decarboxylation; amination; arylation; peptide coupling; aldol condensation; cyclocondensation; dehydrocyclization; esterification; amidation; heterocyclic synthesis; dehydration; alcoholysis; hydrolysis; ammonolysis; etherification; enzymatic synthesis; ketalization; saponification; isomerisation; quaternization; formylation; phase transfer reactions; silylations; nitrile synthesis; phosphorylation; ozonolysis; azide chemistry; metathesis; hydrosilylation; coupling reactions; and enzymatic reactions.

While exemplary embodiments and examples have been set forth for the purpose of illustration, the foregoing description is not intended in any way to limit the scope of disclosure and appended claims. Accordingly, variations and modifications may be made to the above-described embodiments and examples without departing substantially from the spirit and various principles of the disclosure. All such modifications and variations are intended to be included herein within the scope of this disclosure and protected by the following claims.

1. A process of forming an internal mold and using the internal mold to press-mold an internal passage or an internal cavity within a ceramic body, the process comprising:
molding a positive internal mold inside a flexible mold pair formed via first and second flexible mold halves, the flexible mold pair having an internal mold cavity corresponding to the shape and volume of the positive internal mold, the positive internal mold formed of a meltable or sublimable or otherwise heat-removeable material;
removing the first and second flexible mold halves from the positive internal mold;
pressing a volume of binder-coated ceramic powder with the positive internal mold inside the volume of powder to form a pressed body;
heating the pressed body to remove the positive internal mold from the pressed body; and
sintering the pressed body to form a monolithic ceramic body having an internal passage or an internal cavity.

2. The process according to claim 1 wherein pressing the volume of binder-coated ceramic powder comprises uniaxial pressing.

3. The process according to claim 1 wherein pressing the volume of binder-coated ceramic powder comprises isostatic pressing.

4. The process according to claim 1 wherein heating the pressed body to remove the positive internal mold comprises pressing the pressed body while heating the pressed body.

5. The process according to claim 1 wherein the first and second flexible mold halves have a relief angle on surfaces of the internal mold cavity in the range of from 2 to 12 degrees.

6. The process according to claim 1 wherein first and second flexible mold halves have a relief angle on surfaces of the internal mold cavity in the range of from 5 to 9 degrees.

7. The process according to claim 1 wherein the first and second flexible mold halves are shaped such that contact surfaces between the first and second flexible mold halves extending away from contact lines adjacent the internal mold cavity extend in a direction non-perpendicular to surfaces of the internal mold cavity at said contact lines.

8. The process according to claim 1 wherein the first and second flexible mold halves are shaped such that contact surfaces between the first and second flexible mold halves extending away from contact lines adjacent the internal mold cavity extend in a direction forming an acute angle with the nearest surface of the internal mold cavity.

9. The process according to claim 1 wherein the second flexible mold half, when assembled with the first flexible mold half, nests inside the first flexible mold half against a surface of the first flexible mold half partially surrounding surfaces of the internal mold cavity of the second flexible mold half

10. The process according to claim 9 wherein the first flexible mold half, when assembled with the second flexible mold half, nests inside the second flexible mold half against a surface of the second flexible mold half partially surrounding surfaces of the internal mold cavity of the first flexible mold half.

11. The process according to claim 10 wherein the first and second flexible mold halves have a release angle in the range of from 2 to 12 degrees where they nest inside each other.

12. The process according to claim 9 wherein the first and second flexible mold halves have a release angle in the range of from 2 to 12 degrees where the second flexible mold half nests inside the first flexible mold half.

13. The process according to claim 9, wherein portions of the respective first and second flexible molds which nest inside each other extend continuously around the internal mold cavity.

14. The process according to claim 1 wherein making or obtaining first and second flexible mold halves comprises casting or molding the first flexible mold half with a master mold, positioning an insert mold, corresponding to the shape of the positive internal mold to be formed later, in the first flexible mold half, and casting or molding the second flexible mold half on the first flexible mold half with the insert mold positioned therein.

15. The process according to claim 1 wherein molding a positive internal mold inside the flexible mold pair comprises feeding a meltable or sublimable or otherwise heat-removeable material in liquid form into the internal mold cavity of the flexible mold pair, and cooling, or allowing to cool, the flexible mold pair to solidify the material.

16. The process according to claim 15 wherein feeding a meltable or sublimable or otherwise heat-removeable material in liquid form into the internal mold cavity of the flexible mold pair comprises feeding the material by a gravity-driven flow.

17. The process according to claim 15 wherein feeding a meltable or sublimable or otherwise heat-removeable material in liquid form into the internal mold cavity of the flexible mold pair comprises withdrawing the material in liquid form from beneath a surface of a liquid pool of the material and allowing the withdrawn liquid to flow by gravity into the internal mold cavity.

18. The process according to claim 1 wherein the meltable or sublimable or otherwise heat-removeable material comprises a rosin-containing wax.

19. The process according to claim 1 wherein the first and second flexible mold halves comprise silicone.

20. The process according to claim 1 wherein removing the first and second flexible mold halves from the positive internal mold comprises bending or pealing back the first and second flexible mold halves.
